(19) United States
(12) Patent Application Publication
(10) Pub. No.: US 2003/0147464 A1
(43) Pub. Date: Aug. 7, 2003

(54) Method of performing a processing of a multimedia content

(76) Inventors: Myriam C. Amielh-Caprioglio, Paris (FR); Sylvain Devillers, Paris (FR); Francois Martin, Eindhoven (NL)

Correspondence Address: PHILIPS ELECTRONICS NORTH AMERICAN CORP, 580 WHITE PLAINS RD, TARRYTOWN, NY, 10591, US

(21) Appl. No.: 10/324,814

(22) Filed: Dec. 20, 2002

(30) Foreign Application Priority Data
Dec. 28, 2001 (FR) 0116997

(51) Int. Cl. H04N 7/12

(52) U.S. Cl. 375/240.08; 375/240.26

(57) ABSTRACT

The invention relates to a method of performing a processing of a multimedia content. The method according to the invention comprises performing said processing by analyzing a structured description of a bit stream obtained from coding said multimedia content. The description is advantageously written in a markup language such as XML.

In a first embodiment said processing comprises the generation of coding data exclusive of the coding format, relating to the bit stream and adding them to the description (cut between video sequences, character depending on or independent of the coding of elementary video units, presentation time and decoding time . . . ).

In a second embodiment said processing is an applicable processing (reading of a video stream based on a point defined by a user, copying, pasting, video sequence concatenation . . . ).

### FIELD OF THE INVENTION

The present invention relates to a method of processing at least one multimedia content. The invention also relates to a product obtained from implementing such a method, and applications of such a product.

The invention also relates to a program comprising instructions for implementing such a method when it is executed by a processor.

The invention also relates to equipment comprising means for implementing such a method and a system comprising a first and a second entity, said first entity being intended for producing a bit stream obtained from coding said multimedia content according to said encoding format, and said second entity being intended to execute said processing.

The invention has important applications in the field of multimedia content creation and manipulation. It relates to consumer applications and professional applications.

### BACKGROUND OF THE INVENTION

International patent application WO 01/67771 A2 filed Mar. 7, 2001 describes a method of describing a digitized image composed of pixels, utilizing one of the languages XML, HTML, MPEG-7. This description comprises data relating to zones of the image. Such a method is intended to be used for the transmission of cartographic data in order to enable a user to indicate in a request the image zone he wishes to receive.

### SUMMARY OF THE INVENTION

The invention proposes another type of applications using descriptions of the type mentioned above.

A method according to the invention of processing at least one multimedia content is characterized in that it comprises a syntax analysis step of analyzing a structured description of a bit stream obtained from the coding of said multimedia content according to a certain coding format, to recover in said description one or more coding data included in said coding format, and an execution step of executing said processing based on the one or plurality of coding data. Said description is written, for example, in a markup language.

A system according to the invention comprises a first entity intended to produce a bit stream obtained from coding a multimedia content according to a certain coding format and a structured description of said bit stream, and a second entity intended to perform a syntax analysis of said description to recover in said description one or more coding data included in said coding format, and to perform a processing of said multimedia content based on the one or plurality of coding data.

And equipment according to the invention comprises syntax analysis means for analyzing a structured description of a bit stream obtained from the coding of a multimedia content according to certain coding format, to recover in said description one or more coding data included in said coding format and means for executing a processing of said multimedia content based on said one or plurality of coding data.

To obtain a processing of a multimedia content the invention thus comprises the use of a structured description of a bit stream obtained from coding said multimedia content according to a certain coding format. In accordance with the invention the coding data necessary for the processing are not directly recovered in the bit stream but from a structured description of the bit stream.

The invention offers various advantages:

The syntax analysis of the bit stream, which is a heavy operation, is carried out non-recurrently to generate a description of the bit stream. The generated description can then be used by a variety of applications.

The applications using such a description for performing a processing do not need to know the coding formats used for encoding the multimedia contents, because they do not need to carry out the syntax analysis of the bit stream. It is sufficient for them to know the language in which a description is written.

A same application may consequently carry out a same processing of various coding formats.

In a first embodiment said processing comprises a step of generating coding information, exclusive of said coding format, relating to said bit stream, and a step of adding said coding information to said description. In this first embodiment of the invention the description of the bit stream is enriched with coding information which is generated on the basis of coding data directly recovered in the bit stream. Such an enriched description can subsequently be used by a variety of applications.

In a first example of application said multimedia content contains a series of video sequences, and said coding information is indications for cuts between two video sequences. Such cut data between video sequences are advantageously used in applications for cutting, pasting, concatenating video streams.

In a second example of application said multimedia content contains a plurality of elementary units to which a display time and a decoding time correspond, while the coding of an elementary unit depends on or is independent of other elementary units, and said coding information comprises:

indications of whether the coding of said elementary units is dependent on, or independent of the other elementary units,

an indication of said display time,

an indication of said decoding time.

Such coding data are advantageously used to start a reading of said multimedia content from a point chosen by a user.

In a second embodiment said processing comprises a step of cutting part of a bit stream obtained from coding a multimedia content, and/or a step of pasting part of a first bit stream obtained from coding a first multimedia stream in a second bit stream obtained from coding a second multimedia content, and/or a step of concatenating part of a first bit stream obtained from coding a first multimedia content with part of a second bit stream obtained from coding a second multimedia content.

In a third embodiment said bit stream is structured in elementary units comprising an audio part and a video part, the recovered coding data in the description of said bit stream are constituted by at least one descriptor of the audio part of an elementary unit, and said processing comprises a step of modifying said audio part.

### BRIEF DESCRIPTION OF THE DRAWING FIGURES

These and other aspects of the invention are apparent from and will be elucidated, by way of non-limitative example, with reference to the embodiment(s) described hereinafter.

In the drawings:

FIG. 1 represents a functional diagram of an example of a method according to the invention for processing a multimedia content,

FIG. 2 is a flow chart describing the steps of a first example of a method according to the invention,

FIG. 3 is a flow chart describing the steps of a second example of a method according to the invention,

FIG. 4 is a flow chart describing the steps of a third example of a method according to the invention,

FIG. 5 is a block diagram representing a system according to the invention.

### PREFERRED EMBODIMENTS

In FIG. 1 is represented a block diagram of an example of a method according to the invention of processing a multimedia content. A block CT represents a multimedia content. A block COD represents a coding operation according to a certain coding format, of the multimedia contents CT. A block BIN represents a bit stream obtained from coding the multimedia content CT. A block P0 represents a syntax analysis operation for analyzing the bit stream BIN in order to produce a structured description of said bit stream BIN. A block DN represents a structured description of the bit stream BIN. A block P1 represents a syntax analysis operation of the description DN for the recovery of one or more coding data D1 in the description DN. A block T1 represents a processing operation based on the one or plurality of coding data D1 recovered in the description DN. Optionally, the processing T1 comprises a step of generating coding information IF, which coding information relates to the bit stream BIN, and a step of adding coding information IF to the description DN. The coding information D1 is data in the coding format. They can thus be recovered in the description DN by a simple syntax analysis. The coding information IF is data excluded from the coding format which are obtained by processing the coding information D1.

The description DN a structured description of the bit stream BIN, that is to say, that a certain representation level of the structure of the bit stream is directly apparent in the description DN (the structure of the bit stream depends on the coding format used).

In an advantageous manner the description DN is written in a markup language. A markup language is a language that uses marks and defines rules for using these marks for describing the syntax of a set of data (the bit stream here). Such a language thus permits to structure a set of data, that is to say, to separate the structure of all the data from its content. By way of example the XML language (eXtensible Markup Language) defined by the W3C consortium is used.

It is an object of the operation P0 of analyzing the syntax of the bit stream BIN to generate a structured description DN of the bit stream.

In a first embodiment to the invention it is an object of the syntax analysis operation P1 of the description DN to enrich the structured description DN with coding information IF excluded from the coding format. Such an enriched description may then be used to carry out processings which can be applied to the multimedia content.

In a second embodiment of the invention it is an object of the syntax analysis operation P1 of the description DN to execute a processing which can be applied to the multimedia content.

In the following will be given examples of these two embodiments of the invention while use is made of various video coding formats.

A video generally comprises a plurality of video sequences each constituted by a plurality of elementary units which have a decoding time and a display time. In the MPEG-2 coding standard, for example, these elementary units are called frames and a group of frames is called GOP (Group of Pictures). In the MPEG-4 coding standard these elementary units are called VOPs (Video Object Plane) and a group of VOPs is called GOVs (Group of VOPs). The coding of an elementary unit may be independent of or dependent on other elementary units. For example, in the MPEG-2 and MPEG-4 coding standards, an elementary unit coded independently of the other elementary units is called type-I elementary unit. A prediction-coded elementary unit relative to a preceding elementary unit is called a type-P elementary unit. And a prediction-coded elementary unit which is bidirectional relative to a preceding elementary unit and a future elementary unit is called a type B elementary unit.

### EXAMPLE 1

Now a first example of embodiment of the invention will be given in which it is an object of the processing T1 to generate coding information to be added to the description DN. The pasting of a video sequence to a next video sequence corresponds to a cut in the video. In this first example the coding information added to the description is data which permits of locating the cuts between the video sequences. Such data are often useful in the applications of video manipulation because they permit, for example, the user to identify the start of the video sequences he wishes to extract from a video. They are also useful in automatic table of contents extraction applications.

In this first example the case is considered where the video is coded in accordance with one of the coding standards MPEG-2 or MPEG-4 and where the cuts between video sequences coincide with the starts of the groups GOPs or GOVs. Such a coincidence between the video sequence cuts and the start of the groups GOPs or GOVs is possible when the broadcast of the video is not subjected to real-time constraints, because in that case the coding may take the low-level structure into account of the multimedia content (in the present case intra video sequence cuts are taken into account). Typically this is the case when the video is produced in a studio.

In this first example, each sequence cut thus corresponds to a start of GOP or GOV. But as the period of the GOPs or GOVs is small, each start of GOP or GOV does not of necessity correspond to a video sequence cut.

A known technique for calculating the positions of the sequence cuts in a video comprises calculating and comparing the energy of the first type-I elementary units of the groups GOPs or GOVs.

In this first example the description DN notably contains:

a descriptor for describing each group of elementary units of the bit stream,

a descriptor for describing each elementary unit of a group of elementary units. In an advantageous manner the descriptors describing an elementary unit contain a pointer to the part of the bit stream that contains the data corresponding to said elementary unit.

Hereinbelow will be given a non-limiting example of an XML description of a part of a bit stream coded in accordance with the MPEG-4 standard, which may be used for implementing this first example of a method according to the invention:

<?xml version=“1.0” encoding=“UTF-8”?>
<mpeg4bitstream>

<VOS>

<VOSheader>akiyo.mpg4#0-20</VOSheader>
<VO>

<VOL>

<VOLheader>akiyo.mpg4#21-50</VOLheader>
<GOV>

<I_VOP>akiyo.mpg4#51-100</I_VOP>
<remainder>akiyo.mpg4#101-200</remainder>

</GOV>
<GOV>

<I_VOP>akiyo.mpg4#201-300</I_VOP>
<remainder>akiyo.mpg4#301-400</remainder>

</GOV>
...

</VOL>

<VO>

</VOS>

</mpeg4bitstream>

In this first example the syntax analysis of the description DN permits to find the first type-I elementary units of the group GOPs or GOVs. Thus by searching in the description for the descriptors relating to a first type-I elementary units of the groups GOPs or GOVs, the data of said elementary units are recovered via the pointer contained in these descriptors.

The processing T1 then permits to calculate the energy of each of these first type-I elementary units, and to compare the calculated energies. The considerable variations of energy correspond to the sequence cuts. Finally, an indicator of the start of a video sequence having a Boolean value VRAI is added to the description for the groups GOPs or GOVs which correspond to sequence starts. A start indicator of a video sequence having a Boolean value FAUX is added to the description for all the other groups GOPs or GOVs.

Hereinbelow will be given a version of the description DN in which indicators of sequence starts have been added. These indicators are constituted by attributes <<scenCutFlag>> added to the elements <<GOV>>.

<?xml version=“1.0” encoding=“UTF-8”?>
<mpeg4bitstream>

<VOS>

<VOSheader>akiyo.mpg4#0-20</VOSheader>
<VO>

<VOL>

<VOLheader>akiyo.mpg4#21-50</VOLheader>
<GOV sceneCutFlag=“1”>

<I_VOP>akiyo.mpg4#51-100</I_VOP>
<remainder>akiyo.mpg4#101-200</remainder>

</GOV>
<GOV sceneCutFlag=“0”>

<I_VOP>akiyo.mpg4#201-300</I_VOP>
<remainder>akiyo.mpg4#301-400</remainder>

</GOV>
...

</VOL>

</VO>

</VOS>

</mpeg4bitstream>

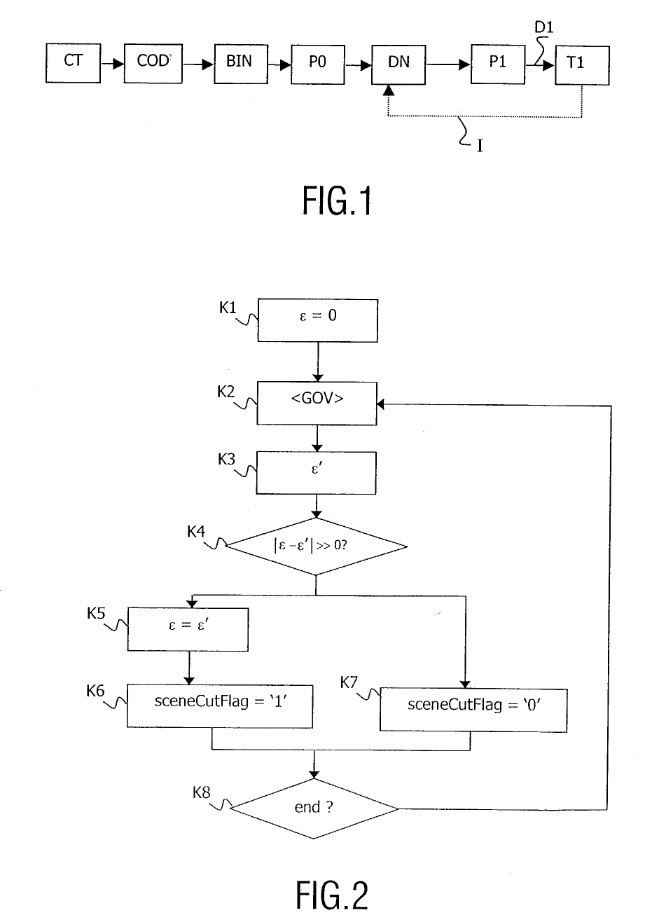

In FIG. 2 is shown a flow chart describing the steps of this first example of the method according to the invention. According to FIG. 2, in box K1 a variable ε is initialized (ε=0). Then the following operations are carried out in a loop:

in box K2 the following XML tag is searched for corresponding to a group of GOPs or GOVs (in the example above these tags are denoted <<GOV>>).

in box K3 the tag relating to the first type-I elementary unit is searched for of the current group GOP or GOV <<tag>I_frame>> in the example above), the corresponding pointer is recovered, for example akiyo.mpg4#51-100, in the example above) and the energy ε′ of the elementary unit located in the bit stream at the location indicated by this pointer is calculated.

in box K4 are compared ε and ε′. If |ε-ε′|>>0 (where the sign >> signifies much greater than), the processing is proceeded with in box K5. If not, it is proceeded with in box K7.

in box K5 the value ε′ is given to the variable ε (ε=ε′).

in box K6 a start indicator of the video sequence is added, having a Boolean value VRAI in the description of the current group GOP or GOV (in the example above this indicator is constituted by an attribute <<sceneCutFlag=‘1’>> added to the element <<GOV>>). The processing is then proceeded with in box K8.

in box K7 is added a start indicator of the video sequence which has a Boolean value FAUX in the description of the current group GOP or GOV (in the example above this indicator is constituted by an attribute <<sceneCutFlag=‘0’>> added to the element <<GOV>>). Then the processing is proceeded with in box K8.

in box K8 is verified whether the whole description has been passed through. If this is the case, the processing is terminated. If not, the processing is resumed in box K2.

### EXAMPLE 2

A second example of embodiment of the invention will now be given in which the processing T1 has for an object to generate coding information to be added to the description DN. The enriched description which is generated in this second example is intended to be used for starting a reading of the multimedia content from a point chosen by a user (for example, the user moves a cursor over a small rule to position the start point from which he wishes to display the video). The enriched description intended to be used for executing such an application is to contain for each elementary unit:

the character depending on/independent of the coding of the elementary unit (randomAccessPoint),

the presentation time of the elementary unit (presentationTime),

the decoding time of the elementary unit (decodingTime),

a pointer to the part of the bit stream that contains the data corresponding to the elementary unit (bitstream.mpg4#251-900 for example).

The position of the elementary units in the bit stream is given by the pointer. The position is notably used for determining in the description DN the elementary unit that corresponds to the start point chosen by the user. The character that depends on/is independent of the coding of the elementary units is used for searching in the description DN for the independently coded elementary unit which is nearest to the elementary unit that corresponds to the start point chosen by the user (the decoding can actually only commence after an independently coded elementary unit). The presentation time and decoding time of the elementary unit selected as a start point are then calculated from data recovered in the description DN and transmitted to the decoder. The data to be decoded are recovered in the bit stream via the pointer so as to be transmitted to the decoder.

Hereinbelow a non-limiting example will be given of an XML description of a part of a bit stream coded in accordance with the MPEG-4 standard, which may be used for implementing this second example of the method according to the invention.

<?xml version=“1.0” encoding=“UTF-8”?>
<MPEG4videoBitstream>

<VO>bitstream.mpg4#0-50</VO>
<VOL>

...

<vop_time_increment_resolution>0110100110100101<vop_time_increment_

resolution>

<fixed_vop_rate>1</fixed_vop_rate>

<fixed_vop_time_increment>0101101010010110</fixed_vop_time_increment

>

...

</VOL>
<GOV>bitstream.mpg4#220-250</GOV>
<I_VOP>bitstream.mpg4#251-900</I_VOP>
<P_VOP>bitstream.mpg4#901-1020</P_VOP>
<B_VOP>bitstream.mpg4#1021-1100</B_VOP>
...

</MPEG4videoBitstream>

An MPEG-4 stream contains a VOL layer (Video Object Layer) which itself contains a plurality of groups GOVs. In the description above, the element <<VOL>> describes the content of the header of the layer VOL. It particularly contains:

1) an element <<vop_time_increment_resolution>> which indicates the value of a time unit (called tick);

2) an element <<fixed_vop_rate>> which has a binary value: when the element <<fixed_vop_rate>> equals <<1>>, all the elementary units VOPs in the groups GOV of the layer VOL are coded with a fixed VOP rate; when the element <<fixed_vop_rate>> equals <<0>>, the presentation time of an elementary VOP unit is calculated from the <<vop_time_increment_resoluton>> contained in the header of the layer VOL and from data <<modulo_time_base>> and <<vop_time_increment>> which are contained in each VOP header (<<modulo_time_base>> is a local time base expressed in milliseconds, and <<vop_time_increment>> indicates a number of time units (ticks) from a synchronization point itself defined by the <<modulo_time_base>>);

3) an element <<fixed_vop_time_increment>> which is used for calculating this fixed VOP rate; the value of the element <<fixed_vop_time_increment>> represents the number of ticks between two successive VOPs in the order of presentation.

These three data thus permit to calculate the value of the presentation time of an elementary unit. The value of the decoding time of an elementary unit is derived, for example, from the value of the presentation time of said elementary unit while a fixed difference denoted δ is added.

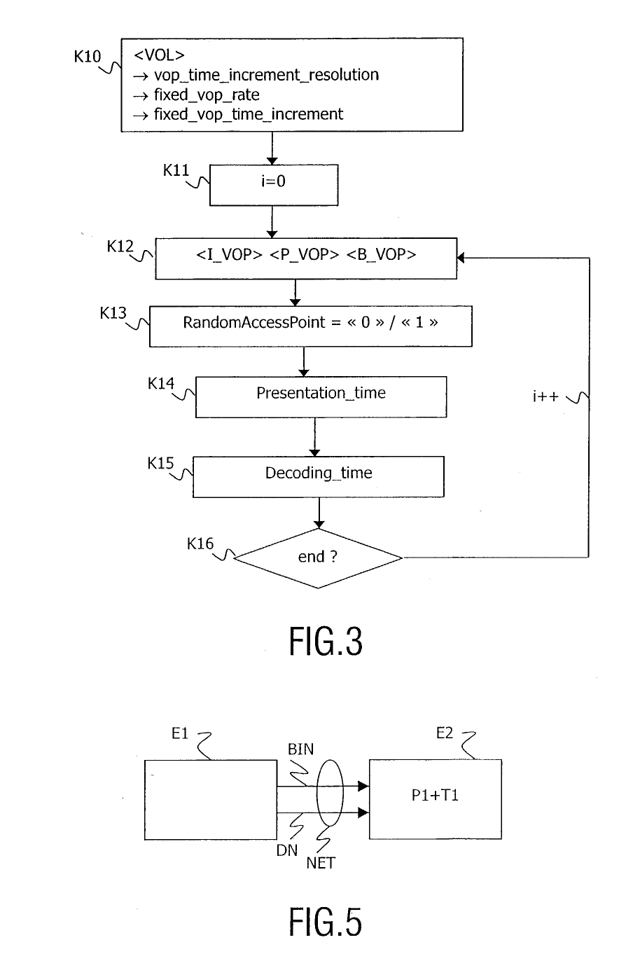

In FIG. 3 is shown a flow chart describing the steps of this second example of the method according to the invention:

in box K10 the tag XML corresponding to the header of the layer VOL is searched for and the data <<vop_time_increment_resolution>>, <<fixed_vop_rate>> and <<fixed_vop_time_increment>> are recovered.

in box K11 a variable i is initialized (i=0). Then the following operations are carried out in a loop:

in box K12 the next tag XML corresponding to an elementary unit VOP(i) (in the example above these tags are denoted <<I_VOP>>, <<P_VOP>> and <<B_VOP>>) is searched for.

in box K13 an indicator of the character depending on or independent of the coding of the current elementary unit is added to the description of the current elementary unit. In the example given below this indicator is constituted by an attribute denoted randomAccessPoint which has a Boolean value:

if the elementary unit is of the type I, randomAccessPoint=<<1>>

if the elementary unit is of the type P or B, randomAccessPoint=<<0>>.

in box K14 the presentation time is calculated for the current elementary unit VOP(i):

if fixed_vop_rate=1 then

presentation_time(i)=presentation_time(i−1)+(fixed_vop_time_increment/vop_time_increment_resolution)

if fixed_vop_rate=0 then

presentation_time(i)=f(modulo_time_base, vop_time_increment/vop_time_increment_resolution)

And the value obtained is added, in the description of the current elementary unit (in the example below an attribute denoted presentation_time is added to the current element <<VOP>>).

in box K15 the decoding time of the current elementary unit is calculated:

decoding_time(i)=presentation_time(i)+δ

And the value obtained is added in the description of the current elementary unit (in the example below an attribute denoted decoding_time is added to the current element <<VOP>>.

in box K16 is verified whether the description has been passed through. If this is the case, the processing is terminated. If not, the variable i is incremented and the processing is resumed in box K12.

Now will be given an enriched example of description obtained while using a method as described with reference to FIG. 3:

<?xml version=“1.0” encoding=“UTF-8”?>
<MPEG4videofBitstream>

<header>bitstream.mpg4#0-200</header>
<VOP presentation_time= “0.40” decoding_time= “0.80”

randomAccessPoint= “1”>

bitstream.mpg4#251-900</I_VOP>

<VOP presentation_time=“0.80” decoding_time= “1.20”

randomAccessPoint= “0”>

bitstream.mpg4#901-1020</P_VOP>

<VOP presentation_time= “1.20” decoding_time= “1.60”

randomAccessPoint= “0”>

bitstream.mpg4#1021-1100</B_VOP>

...

</MPEG4videoBitstream>

This enriched description contains only the data necessary for executing the application considered (start of the reading of a video from a random point fixed by the user). Notably the elements <<VO>>, <<VOL>> and <<GOV>> of the initial description obtained from a syntax analysis of the bit stream have been regrouped in a single element denoted <<header>>. A same element <<VOP>> is used for all the types of elementary units (I, P or B). Attributes presentation_time, decoding_time and randomAccessPoint have been added to these elements <<VOP>>.

### EXAMPLE 3

Now will be given a third example of implementing the invention in which the processing T1 is a processing that can be applied to the multimedia content. The applicable processing considered here by way of example is a concatenation of two video sequences coming from two different bit streams. In this type of application a user chooses in a random fashion a first point of concatenation in a first video and a second point of concatenation in a second video. The part of the first video situated before the first point of concatenation is intended to be concatenated with the part of the second video situated after the second concatenation point. But these concatenation points are to be corrected so that:

the elementary units situated in the first video before the first concatenation point can be decoded;

the elementary units situated in the second video after the second concatenation point can be decoded.

When the videos are coded in accordance with the MPEG-2 or MPEG-4 standard, the elementary units are of the type I, P or B. In this case the second concatenation point is to be situated before a type-I elementary unit. And for the type-B elementary units to be decoded (which are coded with reference to two type-I or type-P elementary units which surround them), it is necessary for the first concatenation point to be placed after a type-I or type-P elementary unit.

Hereinbelow will be given an example of the description of a bit stream coded in accordance with the MPEG-2 standard, which description may be used for implementing this third example of the method according to the invention.

<?xml version=“1.0” encoding=“UTF-8”?>
<!--Bitstream description for MPEG video file akiyo.mpg-->
<mpegbitstream>
<Header>

...
<frame_rate> 0.25 </frame_rate>
...

</Header>

<I_FRAME>akiyo.mpg#18-4658</I_FRAME>
<P_FRAME>akiyo.mpg#4659-4756</P_FRAME>
<B_FRAME>akiyo.mpg#4757-4772</B_FRAME>
<B_FRAME>akiyo.mpg#4773-4795</B_FRAME>
<P_FRAME>akiyo.mpg#4796-4973</P_FRAME>
<B_FRAME>akiyo.mpg#4974-5026</B_FRAME>
<B_FRAME>akiyo.mpg#5027-5065</B_FRAME>
<P_FRAME>akiyo.mpg#5066-5300</P_FRAME>
<B_FRAME>akiyo.mpg#5301-5366</B_FRAME>
<B_FRAME>akiyo.mpg#5367-5431</B_FRAME>
<P_FRAME>akiyo.mpg#5432-5705</P_FRAME>
<B_FRAME>akiyo.mpg#5706-5779</B_FRAME>
<B_FRAME>akiyo.mpg#5780-5847</B_FRAME>
<I_FRAME>akiyo.mpg#5848-10517</I_FRAME>
<B_FRAME>akiyo.mpg#10518-10933</B_FRAME>
<B_FRAME>akiyo.mpg#10934-11352</B_FRAME>
<P_FRAME>akiyo.mpg#11353-11943</P_FRAME>
<B_FRAME>akiyo.mpg#11944-12096</B_FRAME>
<B_FRAME>akiyo.mpg#12097-12306</B_FRAME>
<P_FRAME>akiyo.mpg#12307-12967</P_FRAME>
<B_FRAME>akiyo.mpg#12968-13198</B_FRAME>
<B_FRAME>akiyo.mpg#13199-13441</B_FRAME>
<P_FRAME>akiyo.mpg#13442-13911</P_FRAME>
<B_FRAME>akiyo.mpg#13912-14086</B_FRAME>
<B_FRAME>akiyo.mpg#14087-14313</B_FRAME>

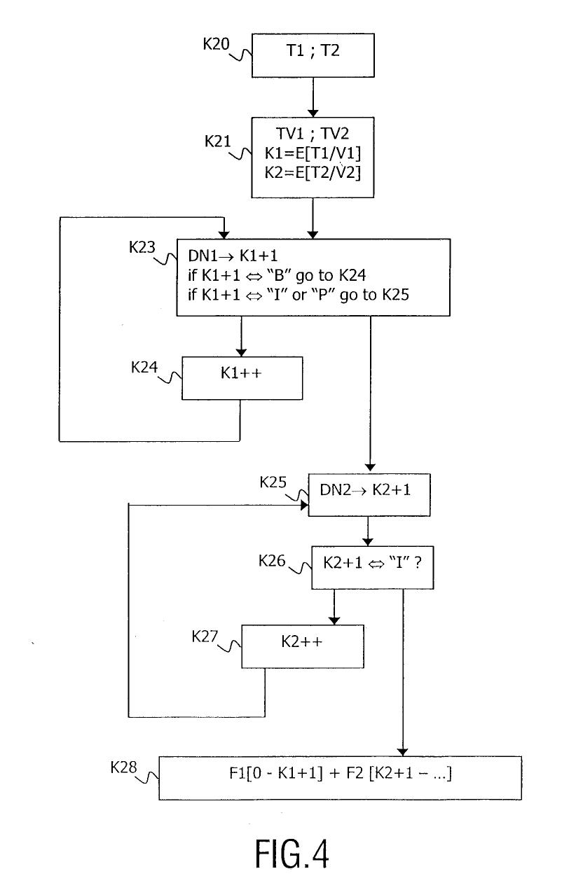

FIG. 4 represents a flow chart describing the steps of this third example of the method according to the invention. Such a method utilizes a first description DN1 of a first bit stream F1 obtained from the coding of a first video V1 and a second description DN2 of a second bit stream F2 obtained from the coding of a second video V2.

In box K20 a user chooses a first concatenation instant T1 in the first video V1 and a second concatenation instant V2 in the second video V2.

In box K21 the image rates TV1 and TV2 of the videos V1 and V2 are recovered in the descriptions DN1 and DN2. A first image rank K1 is calculated from the instant T1 and from the rate TV1 (K1=E[T1/TV1] where E is the integer part function). A second image rank K2 is calculated from the instant T2 and from the rate TV2 (K2=E[T2/TV2]).

In box K23 the description DN1 is passed through up to the (K1+1)^{th} image. If the (K1+1)^{th} image is an image of the type I or type P, the method is then proceeded with in box K25. If not, it is proceeded with in box K24.

In box K24 the image rank K1 is incremented (K1=K1+1) and the method is resumed in box K23.

In box K25 the description DN2 is run through up to the (K2+1)^{th} image.

In box K26 is verified whether the (K2+1)^{th} image is a type-I image. If this is the case, the method is then proceeded with in box K28. If not, it is proceeded with in box K27.

In box K27 the image rank K2 is decremented (K2=K2−1) and the method is resumed in box K25.

Finally, in box K28 the images of the bit stream F1 of a rank lower than or equal to (K1+1) and the images of the bit stream F2 of a rank higher than or equal to (K2+1) are concatenated.

In another embodiment (not shown) the method according to the invention takes into account cuts between video sequences for a correction of the first and second concatenation points chosen by the user.

A man of skill in the art will easily adapt the method that will now be described by way of example to obtain a method for carrying out cut or paste processes.

The H263 standard published by the ITU (International Telecommunications Union) relates to video coding for video telephony applications. This standard utilizes similar notions to the notions of elementary type-I, P and B units defined in the MPEG standards. A method of the type that has just been described is thus applicable to a multimedia content coded according to the H263 standard.

The MJPEG standard (Motion JPEG) is a video compression standard for storage applications and more particularly for studio storage applications. MJPEG is an adaptation of the JPEG standard for video: each elementary unit is coded in independent manner (type-I coding) while the JPEG standard is utilized. The operations of concatenation, cutting and pasting are thus simpler to realize when the multimedia contents are coded according to the MJPEG standard. In that case the only problem to be taken into consideration is the problem of cuts between video sequences.

### EXAMPLE 4

Now a fourth example of implementation of the invention will be given in which the processing T1 is a processing applicable to the multimedia content. This fourth example is applied to video coding standards of the DV (DV, DVCAM, DVPRO) family. DV coding formats utilize a type I compression mode (that is to say, that the compressed elementary units only depend on themselves). And each elementary unit contains both video data and audio data. The applicable processing considered here by way of example is a modification of the audio part of one or more elementary units.

The description of the bit stream that is used for this application is to contain for each elementary unit at least one descriptor describing the audio part of the elementary unit. Advantageously, this descriptor contains a pointer to the part of the bit stream that contains the corresponding audio data. Hereinbelow will be given an example of such a description.

<?xml version=“1.0” encoding“UTF-8”?>
<dvprobitstream>

<videoFrameData>

<firstChannel>

<DIF00>

<Header>akiyo.dvp#21-30</Header>
<Subcode>akiyo.dvp#31-40</Subcode>
<Vaux>akiyo.dvp#41-50</Vaux>
<Audio>akiyo.dvp#51-75</Audio> →

<Audio>akiyo2.dvp#31-55</Audio>

<Video>akiyo.dvp#76-100</Video>

</DIF00>
<DIF10... </DIE10>
...
<DIFN0> ... </DIFN0>

| </firstChannel> | |
|---|---|
| <secondChannel> | ...</secondChannel> |

| </videoFrameData> | |
|---|---|
| <videoFrameData> | ...</videoFrameData> |

...

</dvprobitstream>

In this fourth example the method according to the invention comprises going through the description for selecting one or more elements <<Audio>> and modifying the pointers of said elements <<Audio>>. An example of such a modification has been represented in bold type in the description given above by way of example.

In FIG. 5 is represented a block diagram of a system according to the invention comprising:

a first entity E1 intended to produce a bit stream BIN obtained from coding a multimedia content CT and a structured description DN of the bit stream BIN,

and a second entity E2 intended to perform a syntax analysis P1 of the description DN to recover one or more data D1 in the description DN and to perform a processing T1 of the multimedia content CT from the one or plurality of data D1.

The entities E1 and E2 are generally remote entities. The entity E2 receives, for example, the bit stream BIN and the associated description DN via a transmission network NET, for example, via the Internet.

The examples that have been described have been chosen to illustrate the two embodiments of the invention (the object of the processing being an enrichment of the description of the bit stream and applicable processing of the content), by utilizing various coding formats (MPEG, DVPRO, MJPEG, H263). The invention is not limited to the examples that have been given. It is generally applied to whatever coding format of multimedia content. And it permits to perform a large variety of processings: on the one hand processings which have for an object to enrich a description of a bit stream obtained from coding a multimedia content, and on the other hand processings which can be applied to multimedia contents.

1. A method of performing a processing (T1) of at least one multimedia content (CT), characterized in that it comprises a syntax analysis step (P1) of analyzing a structured description (DN) of a bit stream (BIN) obtained from coding said multimedia content in accordance with a certain coding format, to recover in said description one or more coding data (D1) included in said coding format, and a step of executing said processing from the one or the plurality of said coding data.

2. A method of performing a processing as claimed in claim 1, characterized in that said description (DN) is written in a markup language (XML).

3. A method of performing a processing as claimed in claim 1, characterized in that said processing comprises a step of generating coding information (IF) which are excluded from said coding format and relate to said bit stream (BIN), based on said coding data, and a step of adding said coding information to said description (DN).

4. A method of performing a processing as claimed in claim 3, characterized in that said multimedia content contains a series of video sequences, and said coding information is indications of cuts between two video sequences.

5. A method of performing a processing as claimed in claim 3, characterized in that said multimedia content contains a plurality of elementary units to which correspond a presentation time and a decoding time, the coding of an elementary unit being dependent on or independent of the other elementary units, and said coding information comprises:
indications whether the coding of said elementary units is dependent on, or independent of the other elementary unitary,
an indication of said presentation time,
an indication of said decoding time.

6. A product (DN) describing a bit stream (BIN) obtained from coding a multimedia content (CT) in accordance with a certain coding format, said product being obtained from implementing a method as claimed in claim 3.

7. A utilization of products (DN1, DN2) describing a first and a second bit stream (F1, F2) obtained from coding a first and a second multimedia content (V1, V2) in accordance with a certain coding format, said products being obtained by implementing a method as claimed in claim 4 of cutting a part of said first or said second bit stream and/or pasting a part of said first bit stream in said second bit stream and/or concatenating a part of said first bit stream with a part of said second bit stream.

8. A utilization of a product describing a bit stream obtained from coding a multimedia content in accordance with a certain coding format, said product being obtained by implementing a method as claimed in claim 5, for starting a reading operation of said multimedia content from a point chosen by a user.

9. A method of performing a processing as claimed in one of the claims 1 or 2, characterized in that said processing comprises a step of cutting a part of a bit stream obtained from coding a multimedia content, and/or a step of pasting a part of a first bit stream obtained from coding a first multimedia stream in a second bit stream obtained from coding a second multimedia content and/or a step of concatenating a part of a first bit stream obtained from coding a first multimedia content with a part of a second bit stream obtained from coding a second multimedia content.

10. A method of performing a processing as claimed in one of the claims 1 or 2, characterized in that said bit stream is structured in elementary units comprising an audio part and a video part, the coding data recovered in the description of said bit stream are constituted by at least a descriptor of the audio part of an elementary unit, and said processing comprises a step of modifying said audio part.

11. A program comprising instructions for implementing a method of performing a processing as claimed in one of the claims 1 or 2, when said program is executed by a processor.

12. A system comprising a first entity (E1) intended to produce a bit stream obtained from coding a multimedia content in accordance with a certain coding format and a structured description of said bit stream, and a second entity (E2) intended to perform a syntax analysis of said description for recovering in said description one or more coding data included in said coding format, and for performing a processing of said multimedia content from the one or the plurality of said coding data.

13. Equipment (E2) comprising syntax analysis means for analyzing a description structured in a bit stream obtained from coding a multimedia content in accordance with a certain coding format, for recovering in said description one or more coding data included in said coding format, and means for executing a processing of said multimedia content from the one or the plurality of said coding data.
